(19) United States
(12) Patent Application Publication
(10) Pub. No.: US 2015/0120156 A1
(43) Pub. Date: Apr. 30, 2015

(54) METHOD FOR CONTROLLING A DUAL CLUTCH TRANSMISSION

(71) Applicant: ZF Friedrichshafen AG, Friedrichshafen (DE)

(72) Inventors: Thorsten Leim, Friedrichshafen (DE); Carolin Heller, Friedrichshafen (DE)

(21) Appl. No.: 14/399,230

(22) PCT Filed: May 2, 2013
(86) PCT No.: PCT/EP2013/059100

§ 371 Date: Nov. 6, 2014

(30) Foreign Application Priority Data
Jun. 21, 2012 (DE) 10 2012 210 512.3

(51) Int. Cl. F16H 61/688; F16H 61/02

(52) U.S. Cl. CPC F16H 61/688; F16H 61/0213; F16H 2061/0216
USPC 701/59; 701/51

(57) ABSTRACT

A method of controlling a dual-clutch transmission having two partial transmissions that can be connected to a drive engine such that a target gear, in a respective load-free partial transmission to be engaged following the currently active gear, can be preselected. To reduce the energy consumption caused by transmission losses, the method includes the steps of: determining a possible target gear, determining overall transmission losses for both when a target gear is preselected, and when a target gear is not preselected, determining whether the overall transmission loss is greater when a target gear is preselected or when no gear is preselected, deciding whether a target gear should or should not be preselected using the overall transmission loss determined as a criterion, and implementing measures that correspond to the decision reached.

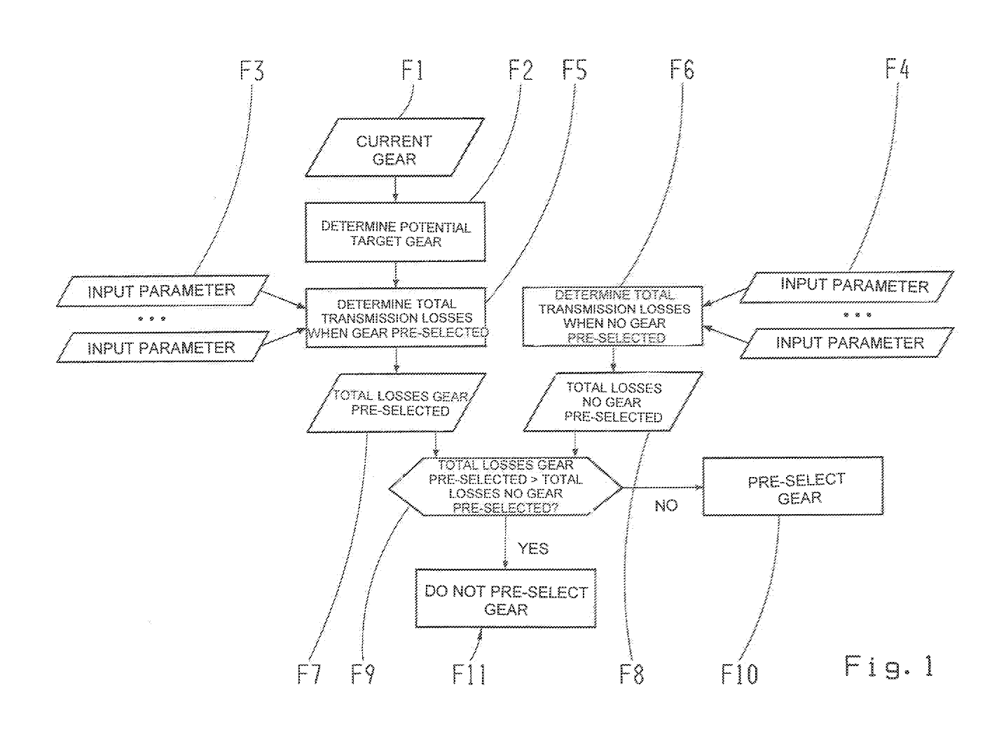

This application is a National Stage completion of PCT/EP2013/059100 filed May 2, 2013 which claims priority from German application serial no. 10 2012 210 512.3 filed Jun. 21, 2012.

### FIELD OF THE INVENTION

The invention concerns a method for controlling a dual-clutch transmission.

### BACKGROUND OF THE INVENTION

Dual-clutch transmissions, which comprise partial transmissions functionally independent of one another, each connected on the input side to a respective clutch by means of which a driving connection to a drive engine can be formed, are known in various designs. In most cases two partial transmissions of countershaft design are provided, which can be fitted axially one behind the other, axially parallel, or nested within one another. In the partial transmissions, by virtue of the gearwheels therein, in a number of wheel planes a respective group of gears is arranged, as a rule such that a group of even-numbered gears can be engaged in one of the two partial transmissions and a group of odd-numbered gears in the other of the two partial transmissions. The two clutches can be arranged in a shared clutch cage with their output sides connected to a respective transmission input shaft, the two transmission input shafts being arranged coaxially with one another and each being connected to one of the two partial transmissions. Other arrangements with parallel transmission input shafts and two single clutches are also known.

In an alternating, in particular sequential series of gearshifts, by virtue of the two partial transmissions such vehicle transmissions can basically be powershifted throughout. When a gear associated with one clutch is active, a target gear or sequential gear in the currently load-free partial transmission, associated with the other clutch, can be preselected. In that case, with the associated clutch on the input side open the shifting elements of the preselected target gear are already closed. The gearshift, with load transfer from one partial transmission to the other, is then carried out by opening and closing the two clutches with overlap. In this way dual-clutch transmissions enable gearshifts largely free from traction force interruption and therefore, compared with conventional transmissions of countershaft structure, they make for greater driving comfort. To enable as comfortable as possible a transfer from the active gear to the next gear, as accurate a knowledge of the clutch performance characteristics as possible is demanded. For that, as described for example in DE 103 08 517 Al , a performance characteristic adaptation is carried out at whichever of the clutches is not under load.

A gear is usually preselected in the currently load-free partial transmission by forming rotationally fixed connections by means of shifting elements which connect gearwheels to transmission shafts and/or transmission shafts to one another. In the currently load-free partial transmission this produces a target rotational speed that corresponds to the transmission ratio of a target gear expected to be engaged. By virtue of the gear preselection absolute rotational speeds and rotational speeds relative to one another are produced at various transmission elements. However, the rotating transmission elements concerned produce drag torques in the load-free partial transmission. The drag torques depend on various parameters, such as moments of inertia, wear condition, frictional coefficients, and the viscosity of lubricant and coolant media. The transmission losses caused thereby are determined by the drag torques and the relevant rotational speeds, and are usually larger, the higher are the rotational speeds or rotational speed differences of the transmission components concerned.

From EP 1 467 127 A1 a method for controlling a dual clutch is known, in which contrary to the usual operating method no target gear is selected in the respective load-free partial transmission for a forthcoming gearshift. In this way problems due to a possible erroneous gear selection are avoided, for example when the next-higher gear has already been preselected but the driver now wants to overtake another vehicle and therefore wishes to carry out a downshift so as to have as much traction force in reserve as possible, or when repeated shift processes in the free partial transmission which are unexpected by the driver have an irritating effect, or when transmission losses occur in particular due to drag torques at an open dual clutch designed as a wet-operating clutch because of a rotational speed difference between the input and the output sides. Instead of a conventional gear preselection, in this known method shifting elements at synchronizers are opened in the currently load-free partial transmission and thereby a gear currently not being used is disengaged. By slightly closing its associated input clutch the then freely rotating partial transmission is brought to the rotational speed of a driveshaft and thus to the rotational speed of a drive engine, and held there. In this way the partial transmission concerned is shifted to a defined starting condition for a subsequent shifting process, wherein the drive-train of the free partial transmission always co-rotates at the engine rotational speed as far as the opening point of the drive engine.

Furthermore, from DE 103 08 689 A1 a method for controlling a dual-clutch transmission having two transmission input shafts is known, each respectively associated with a clutch, in which method, in order to carry out a gearshift from an active gear to a target gear a multi-phase torque control process is carried out. In this case, after the disengagement of a momentarily inactive gear, if no target gear has been preselected the rotational speed of the associated free transmission input shaft falls below a synchronous rotational speed of the target gear because of drag losses and is then synchronized by engaging the clutch concerned.

### SUMMARY OF THE INVENTION

Against this background the purpose of the present invention is to indicate a method for controlling a dual-clutch transmission, which enables the energy consumption caused by transmission losses to be reduced.

This objective is achieved by virtue of the characteristics specified in the description below.

The invention is based on the recognition that in a dual-clutch transmission having two independent partial transmissions, the preselection of a gear in the respective partial transmission not in driving connection with the drive engine produces relative and absolute rotational speeds at various transmission elements, which in the load-free condition are subject to drag torques and which therefore produce drag losses which are usually greater, the higher the rotational speeds are. In contrast, if in the load-free partial transmission a target or next gear is not engaged immediately, then other relative and absolute rotational speeds are produced at the freely rotating transmission components of the drive-train of the partial transmission, which are essentially influenced by transmission losses but not by the preselection of a gear. By virtue of a strategic decision regarding the preselection of a gear it is therefore possible at least temporarily so to minimize the rotational speeds in the respective load-free partial transmission such that, averaged over time, the efficiency of the transmission is improved and thereby consumption savings and ultimately emission savings of the drive unit can be achieved.

Accordingly, the invention starts with a method for controlling a dual-clutch transmission comprising two partial transmissions, each of which is connected on the input side to a respective clutch by means of which a drive connection can be formed to a drive engine, wherein, in whichever of the two partial transmissions is free from load, a target gear that follows a currently active gear can be preselected.

To achieve the stated objective the invention provides the following process sequence: First, a possible target gear is determined. Then, with the help of measurements and/or model calculations and/or variables derived therefrom, an overall loss of the transmission is determined, this being done for a first case in which a target gear has been preselected and for a second case in which no gear has been preselected. With reference to the results it is determined whether the overall loss is greater or smaller when a target gear has been preselected than without any gear preselection. With the help of the overall loss determined as a criterion, it is then decided whether or not a target gear should be preselected in the load-free partial transmission. Finally, to implement the decision reached suitable measures are initiated.

Accordingly, by virtue of a prognostic calculation of the transmission losses with and without preselection of a gear it is possible to record in a transmission control unit a strategic decision concerning whether the preselection of a gear in the load-free partial transmission is appropriate having regard to transmission losses, or whether it should be decided not to preselect any gear. In the latter case the shifting elements in the load-free partial transmission would remain open. For this, in the method proposed it is checked whether the overall losses in the transmission are larger or smaller when a target gear has been preselected, than without any gear preselection, and the result is used as the main criterion for a gear preselection.

According to a preferred embodiment of the invention, the target gear is preselected in the load-free partial transmission when the overall transmission loss anticipated if the target gear is preselected is smaller, or at least not larger than without a gear preselection. In contrast, a gear preselection in the load-free partial transmission is blocked when, if a target gear is preselected, the overall loss is expected to be larger than without gear preselection, In this way consumption and emission savings can be achieved during vehicle operation.

The overall power loss of a transmission is composed of various load-independent and load-dependent fractions, which include gearing losses, bearing losses and seal losses. Basically, according to this transmission, losses can be determined by measurements and mathematical and physical model calculations, wherein the relevant rotational speeds of the drag torque affected transmission components but also a series of other parameters have an influence on the size of the drag losses.

In particular it can be provided that to determine the overall transmission loss, besides the rotational speeds of loss-relevant rotating transmission components, one or more of the parameters bearing losses, gearing losses, seal losses, synchronization losses, clutch losses, splash losses, moment of inertia losses, lubricant viscosity losses and ambient temperature losses are determined and taken into account. Each of these loss components has a characteristic of its own and is rotational speed dependent to a greater or lesser extent. Such losses can be calculated and compared with measurements.

The existing and/or determined and/or evaluated data on overall transmission loss can expediently be stored as performance fields and/or characteristic lines and/or characteristic tables in a memory of a transmission control unit. It that way they are reliably and quickly available for reaching a decision about gear preselection.

To ensure comfortable driving operation at all times, as is made possible per se by virtue of dual-clutch transmissions that enable traction force supported and dynamic gearshifts, other criteria too can be involved in the decision whether or not to preselect a gear. accordingly, it can also be provided that for the decision whether or not to preselect the target gear, current driving condition data are taken into account as additional criteria.

For example, such current driving condition data to be taken into account may include an accelerator pedal position, an accelerator pedal deflection rate, a brake pedal position and/or a brake pedal depression rate of a service brake of the vehicle, a vehicle speed, a vehicle acceleration, a driving resistance and/or the position of a driving direction indicator of the vehicle, which give information about a driver's wish and/or a current driving situation.

Furthermore, it can be provided that for the decision whether or not the target gear should be preselected, a predetermined time interval is taken into account, within which the next gearshift is to be anticipated.

These measures ensure that a gear preselection in the load-free partial transmission is always suppressed if this will increase the efficiency of the transmission and result in a saving of fuel consumption by the vehicle drive, and always takes place if no, or no significant efficiency improvement and fuel saving can be expected, or if the omission of a gear preselection in the load-free partial transmission could result in an impairment of comfort during driving operation.

Moreover, it can be provided that the determination of the target gear and the preselection or not of that target gear are integrated in a control program of a transmission control unit, so that when a gearshift is directly imminent, if necessary, the not preselected target gear is engaged in the load-free partial transmission and by means of the associated clutch and/or the associated synchronous shifting elements the target gear concerned is synchronized, and thereafter the load transfer from the previously load-bearing partial transmission to the previously load-free partial transmission is carried out without traction force interruption by virtue of the gearshift, by controlled actuation of the two clutches.

In that the method is integrated in a transmission control unit and the target gear is engaged by the transmission control unit or by an associated control device if the decision to do this has already been taken, short shifting times and greater shifting comfort during gearshifts without traction force interruption can be achieved, or existing shifting times and existing shifting comfort levels can at least be ensured.

### BRIEF DESCRIPTION OF THE DRAWING

To clarify the invention, the description of a drawing showing an example embodiment is attached. In the drawing, the sole FIGURE shows a flow sequence of a method for controlling a dual-clutch transmission in accordance with the technical principle of the invention.

### DETAILED DESCRIPTION OF THE DRAWING

The dual-clutch transmission of a motor vehicle (not shown but known from the prior art outlined at the beginning) comprises two partial transmissions, such that during driving operation in each case only one of the two is active, i.e. in drive connection via an associated first clutch with a drive engine, whereas the other partial transmission is inactive, i.e. separated by an associated second clutch from the drive engine, thus being free from load.

The FIGURE shows a flow diagram with function blocks F1 to F11 with process steps for reaching the decision whether or not a target gear should be preselected in a currently load-free partial transmission of the dual-clutch transmission.

Thus, according to function block F1 the method begins with a gear currently engaged. In function block F2 a possible target gear or a gear following after the current gear is determined, which basically can be preselected and engaged in the partial transmission that is currently free from load.

Then, with the knowledge of this following gear, the overall loss of the transmission is determined for the cases when that gear is preselected (function block F5) or when no gear is preselected (function block F6). For this, in the process steps represented by function blocks F3 and F4 a number of input parameters 1 . . . n are read into a transmission control unit, which include for example the geometry of transmission elements, local ambient temperatures, bearing losses, seal losses, synchronization losses when engaging gears, clutch losses due to clutch drag torques, splash losses due to rotating drive-trains and others, and which are to a greater or lesser extent dependent on relative and absolute rotational speeds of the transmission elements. The required data and relationships can be taken from performance graphs stored in the transmission control unit, and/or provided by actual measurements evaluated by the transmission control unit.

The result of the process steps in function blocks F5 and F6 is a message or signal which corresponds to the size of the transmission's overall losses. This is represented schematically in function blocks F7 and F8.

The results, i.e. the calculated overall transmission losses alternative to one another undergo a comparison, represented schematically by the decision block F9. Following that comparison, in a function block 10 the expected target gear initially determined is preselected in the load-free partial transmission, i.e. engaged while the associated input clutch is open, provided that the overall losses due to the preselection would not be larger than without the gear preselection. This gear preselection would correspond to a usual, conventional gear preselection in dual-clutch transmissions without any such checking.

In contrast, if the comparison of the alternative overall losses in the decision block F9 reveals that the overall losses with a gear preselected would be greater than without the gear preselection, then in a function block F11 a signal is emitted that no gear preselection should take place and therefore no gear is preselected. With regard to this operating strategy of “conditional gear preselection” this concludes the process.

1-8. (canceled)

9. A method of controlling a dual-clutch transmission which comprises two partial transmissions, each of the partial transmissions being connected, on an input side, via a respective clutch to a drive connection with a drive engine such that, in a respective load-free partial transmission of the two partial transmissions, a target gear that follows a currently active gear is preselectable, the method comprising the steps of:
determining a possible target gear,
determining an overall transmission loss from at least one of measurements, model calculations, and variables derived therefrom, for a first case, in which the target gear is preselected and, for a second case, in which no gear is preselected,
determining whether the overall transmission loss is greater when the target gear is preselected than when no target gear is preselected,
deciding whether the target gear should or should not be preselected, using the overall transmission loss determined as a criterion, and
implementing measures corresponding to the decision reached.

10. The method according to claim 9, further comprising the step of preselecting the target gear if the overall transmission loss, when the target gear is preselected, is either expected to be smaller, or at least not larger than the overall transmission loss without gear preselection, and blocking a gear preselection if the overall transmission loss, when the target gear is preselected, is expected to be larger than the overall transmission loss without gear preselection.

11. The method according to claim 9, further comprising the step of determining and taking into account, when determining the overall transmission loss, rotational speeds of loss-relevant transmission components and at least one of bearing losses, gearing losses, seal losses, synchronization losses, clutch losses, splash losses, moment of inertia losses, lubricant viscosity losses, and ambient temperature losses.

12. The method according to claim 9, further comprising the step of storing at least one of existing, determined and evaluated data of the overall transmission loss as at least one of performance graphs, characteristic curves and tables of characteristics in a memory of a transmission control unit, and recalling the at least one of the performance graphs, the characteristic curves and the tables of characteristics from the memory for reaching a decision concerning a gear preselection.

13. The method according to claim 9, further comprising the step of taking into account current driving condition data as additional criteria for the decision of whether or not to preselect the target gear.

14. The method according to claim 13, further comprising the step of defining the current driving condition data as at least one of an accelerator pedal position, an accelerator pedal actuation rate, a brake pedal position, a brake pedal actuation rate, a vehicle speed, a vehicle acceleration, a driving resistance and a position of a driving direction indicator of the vehicle.

15. The method according to claim 13, further comprising the step of taking into account, as the additional criterion for the decision of whether or not to preselect the target gear, a predetermined time interval within which a following gearshift is expected to occur.

16. The method according to claim 9, further comprising the step of integrating the determination of the target gear and the preselection or non-preselection of that target gear in a control program of a transmission control unit whereby, when a gearshift is directly imminent, a possibly not preselected target gear is engaged in the load-free partial transmission and is synchronized by at least one of the associated clutch and associated synchronous shifting elements of the target gear concerned, and
then carrying out the load transferfrom the previously load-bearing partial transmission to the previously load-free partial transmission without traction force interruption during the gearshift by appropriate actuation of the two clutches.

17. A method of controlling a dual-clutch transmission having first and second partial transmissions, each of the first and the second partial transmission are connected with a respective clutch on an input side thereof, the first and the second partial transmissions are alternately drivingly connectable, via the respective clutches, to a drive engine such that, when shifting from a current gear that is engaged in one of the first and the second partial transmissions, a target gear preselected in the other of the first and the second partial transmission which is currently load-free, the method comprising the following steps:
determinating the target gear;
determinating an overall transmission loss, when a target gear is preselected, from at least one of measurements, model calculations and variables derived therefrom;
determinating an overall transmission loss, when a target gear is unselected, from at least one of measurements, model calculations and variables derived therefrom;
comparing the overall transmission loss when the target gear is preselected to the overall transmission loss when the target gear is unselected;
preselecting the target gear if the overall transmission loss when the target gear is preselected is not greater than the overall transmission loss, when the target gear is unselected; and
discontinuing preselection of the target gear if the overall transmission loss when the target gear is preselected is greater than the overall transmission loss, when the target gear is unselected.
